(19) United States
(12) Patent Application Publication
(10) Pub. No.: US 2017/0105515 A1
(43) Pub. Date: Apr. 20, 2017

(54) SCRUBRUSH

(71) Applicant: Robert A. Marti, Pepperell, MA (US)

(72) Inventor: Robert A. Marti, Pepperell, MA (US)

(21) Appl. No.: 14/885,503

(22) Filed: Oct. 16, 2015

(51) Int. Cl. A46B 11/06; B08B 3/10; A46B 11/00; B08B 1/00; A46B 7/04

(52) U.S. Cl. CPC A46B 11/063; B08B 1/002; A46B 7/04; A46B 11/0072; B08B 3/10; A46B 2200/1013

(57) ABSTRACT

Disclosed herein is a scrub brush system comprising a plurality of bristles extending away from a bottom side of a brush base, the bottom side of the brush base attached to, and in fluid communication with an external fluid reservoir through a flexible conduit. Systems comprising and methods of using the scrub brush are also disclosed.

### BACKGROUND

The statements in this section merely provide background information related to the present disclosure and may not constitute prior art.

Clean hands are crucial to good health. Hand cleaning instruments and cleaners are not readily available where needed. There is a need in the art for a secure hand-cleaning apparatus which includes the cleaner and means for cleaning.

### SUMMARY

Some embodiments are directed to scrub brush systems. Other embodiments include unique systems and methods for utilizing the scrub brush systems disclosed herein. Further embodiments, forms, objects, features, advantages, aspects, and benefits shall become apparent from the below description and drawings.

In an embodiment a scrub brush comprises a plurality of bristles extending away from a bottom side of a brush base, the bottom side of the brush base attached to, and in fluid communication with an external fluid reservoir through a flexible conduit.

In an embodiment, a scrub brush system comprises a scrub brush having a plurality of bristles extending away from a bottom side of a brush base, the bottom side of the brush base attached to, and in fluid communication with an internal compartment of an external fluid reservoir through a flexible conduit, the external fluid reservoir further comprising a pump operable to produce a flow of a fluid disposed within the internal compartment, through the conduit to the bottom side of the brush base.

In an embodiment, a scrub brush system comprises a scrub brush having a plurality of bristles extending away from a bottom side of a brush base, the bottom side of the brush base attached to, and in fluid communication with a flexible internal compartment of an external fluid reservoir through a flexible conduit, the external fluid reservoir further comprising a plunger slidably engaged through an opening in a wall of the external fluid reservoir and arranged in outwardly biased contact with the flexible internal compartment such that application of a force on the plunger in a direction opposite the bias produces a flow of a fluid disposed within the flexible internal compartment through the flexible conduit to the bottom side of the brush base.

### BRIEF DESCRIPTION OF THE SEVERAL VIEWS OF THE DRAWINGS

FIG. 1 is a partially exploded front view of a scrub brush system according to an embodiment of the instant disclosure;

FIG. 2 is a top right side perspective view of a brush base according to an embodiment of the instant disclosure;

FIG. 3 is a top left side perspective view of a brush base according to an embodiment of the instant disclosure;

FIG. 4 is a bottom side perspective view of a brush base according to an embodiment of the instant disclosure;

FIG. 5 is a top side perspective view of a brush base comprising integral bristles according to an embodiment of the instant disclosure;

FIG. 6 is a bottom side perspective view of a brush base comprising integral bristles according to an embodiment of the instant disclosure;

FIG. 7A shows a cross-section of a flexible conduit having an external tether according to an embodiment of the instant disclosure;

FIG. 7B shows a cross-section of a flexible conduit having an integral tether according to an embodiment of the instant disclosure;

FIG. 7C shows a cross-section of a flexible conduit having a tether located within the fluid flow path according to an embodiment of the instant disclosure;

FIG. 8A shows a cross-section of a flexible conduit having a plurality of flow paths according to another embodiment of the instant disclosure;

FIG. 8B shows a cross-section of a flexible conduit having a protective web around the flow path, according to another embodiment of the instant disclosure;

FIG. 9 is a block diagram of the system according to an embodiment of the instant disclosure having a pump; and

FIG. 10 is a block diagram of the system according to an embodiment of the instant disclosure having a plunger assembly.

### DETAILED DESCRIPTION

At the outset, it should be noted that in the development of any such actual embodiment, numerous implementation-specific decisions must be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a physical range listed or described as being useful, suitable, or the like, is intended that any and every value within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific, it is to be understood that inventors appreciate and understand that any and all data points within the range are to be considered to have been specified, and that inventors possessed knowledge of the entire range and all points within the range.

As used in the specification and claims, “near” is inclusive of “at.”

The following definitions are provided in order to aid those skilled in the art in understanding the detailed description.

For purposes herein, a cleaning fluid may include an aqueous or a non-aqueous solution, dispersion, emulsion, gel, and/or slurry.

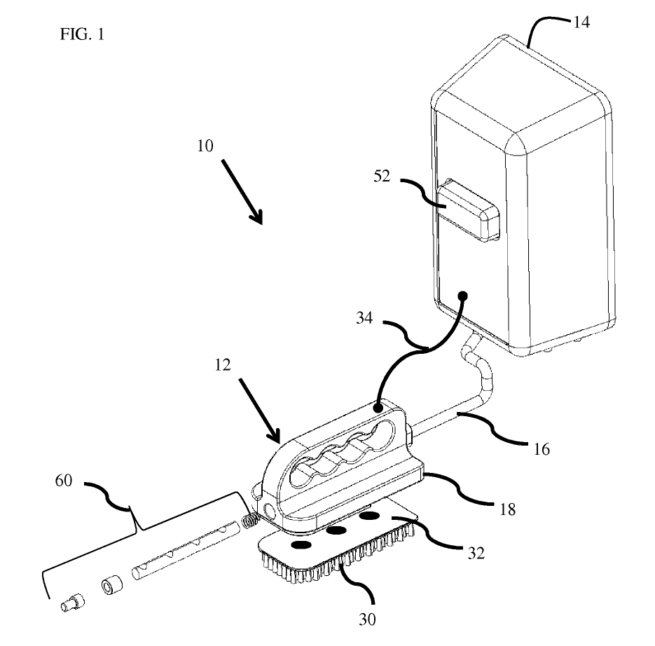

In an embodiment, a scrub brush system comprises a plurality of bristles extending away from a bottom side of a brush base, the bottom side of the brush base attached to, and in fluid communication with an external fluid reservoir through a flexible conduit. As shown in FIG. 1, in an embodiment, a scrub brush system 10 comprises a brush assembly 12 connected to an external fluid reservoir 14 by a flexible conduit 16. In an embodiment, the scrub brush system may further comprise a tether cable 34 attached to each of the brush assembly 12, e.g., to brush base 18, and to the external fluid reservoir 14, which may include attachment of the tether 34 to a housing and/or other structure associated with the external fluid reservoir 14.

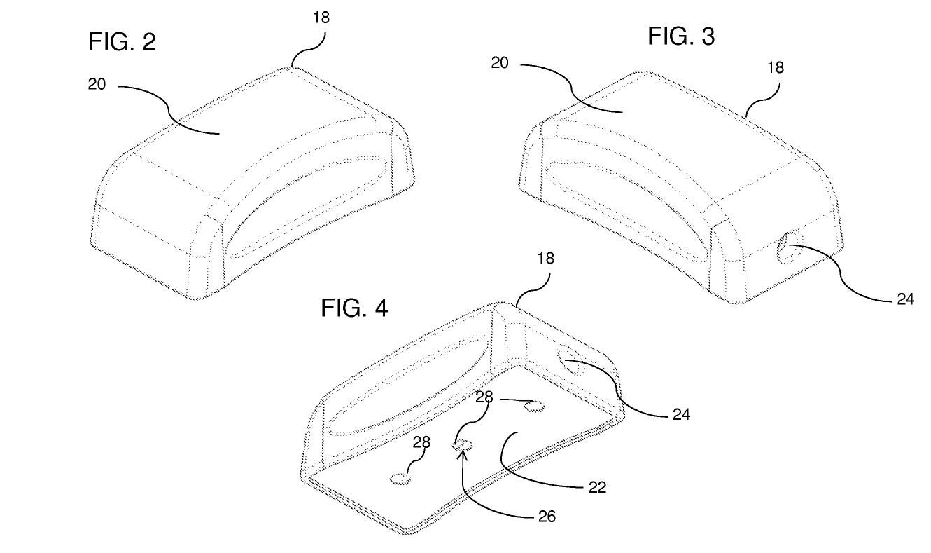

In an embodiment, as shown in FIGS. 2, 3, and 4, the brush assembly may comprise a brush base 18 having a top side 20 and a bottom side 22 (FIG. 4). Flexible conduit 16 may attach to brush base 18 via a fluid inlet 24 disposed in brush base 18. In an embodiment, brush base 18 may comprise a second fluid reservoir 26 located within or on the top side 20 which is in fluid communication with the bottom side 22 via one or more holes 28. Accordingly, in an embodiment, the external fluid reservoir 14 is in fluid communication with the bottom side 22 of the brush base 18 through the second fluid reservoir 26 located between the external fluid reservoir 14 and the bottom side 22 of the brush base 18. In an embodiment, the second fluid reservoir 26 is located on, in, or attached to the top side 20 of the brush base 18.

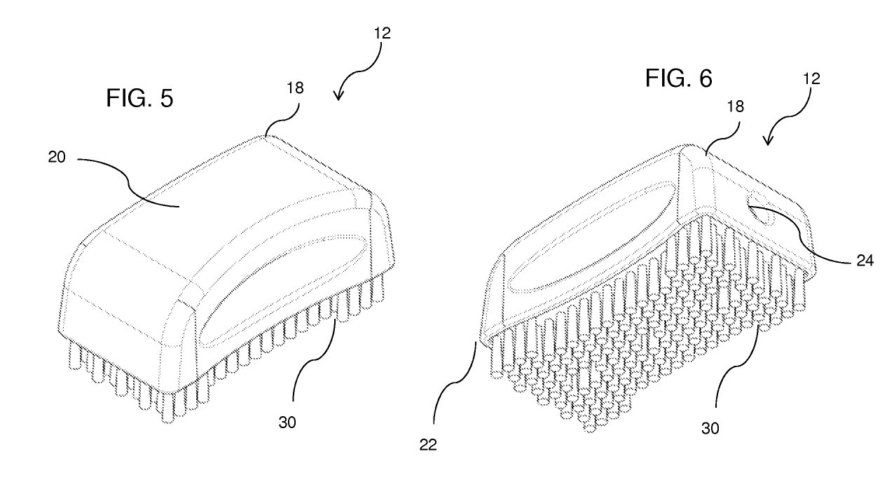

The brush assembly may also comprise a plurality of bristles depending from the bottom side 22 of the brush base 18. As shown in FIGS. 5 and 6, in an embodiment, the plurality of bristles 30 which form the brush may be integral to the brush base 18. Accordingly, the bristles may be formed from the same material which forms the brush base, depend from the bottom side of the brush base, protrude through the bottom side of the brush base, or any combination thereof. In an embodiment, the plurality of bristles may be removable from the brush base individually, in groups, or as a bristle assembly 32, which engages the brush base 18 (See FIG. 1). Accordingly, the bristles 30 of the brush base 18 may be releasably attached to the brush base 18 such that the bristles are part of a disposable or replaceable bristle assembly 32 attachable to the brush base 18 forming the brush assembly 12.

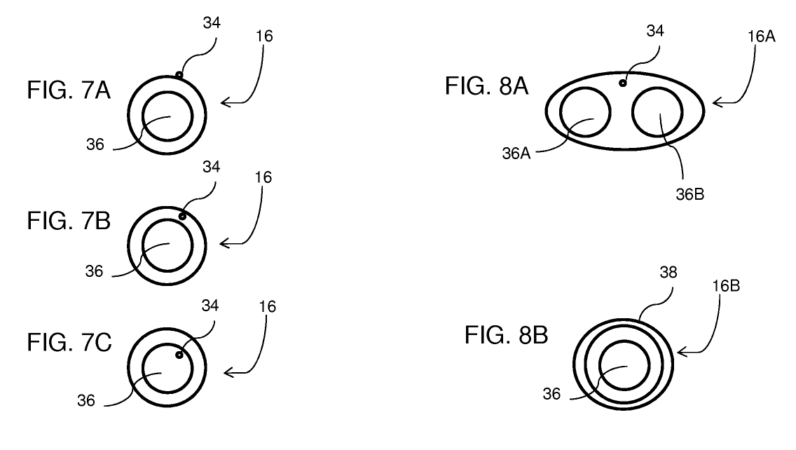

In an embodiment, as shown in FIG. 1, the flexible conduit 16 may comprise a polymeric or flexible metallic tube, pipe, and/or the like comprising a flow path 36 (see FIG. 7A-C) disposed within. Suitable examples include vinyl tubing, polyolefin tubing, braided tubing, nylon tubing, urethane tubing, and/or the like. The flexible conduit may be attached to the external fluid reservoir and/or the brush base by a pressure fit fitting, barbed fitting, welded fitting, threaded fitting, and/or the like, as is readily known to one of minimal skill in the art. In an embodiment, the brush base 18 may further comprise a distribution assembly, shown collectively as 60, which distributes the fluid from the brush base 18 to the bristle assembly 32.

FIGS. 7A, 7B, and 7C each show a cross-section of a flexible conduit 16 having an tether 34 according to embodiments of the instant disclosure. As shown in cross-sectional FIG. 7A, in an embodiment, flexible conduit 16 may include tether 34 attached to an external surface of the flexible conduit 16. In an embodiment, as shown in FIG. 7B, tether 34 may be located integral to the flexible conduit 16. In an embodiment as shown in FIG. 7C, tether 34 may be located within the fluid flow path 36 of flexible conduit 16.

FIG. 8A shows a cross-section of an alternative embodiment of the instant disclosure, wherein flexible conduit 16A has a plurality of flow paths 36A and 36B. FIG. 8B shows a cross-section of an alternative embodiment of the instant disclosure, wherein flexible conduit 16B comprises a protective web or braid 38 around the flow path 36.

In an embodiment, the tether cable 34 prevents removal of the brush assembly 12 from the system 10, thus maintaining a connection between the brush assembly 12 and the external fluid reservoir 14, and may comprise a metallic cable, a steel cable, a nylon or other polymeric cable, and/or the like with a strength sufficient to prevent facile, unintended, and/or mischievous removal of the brush base 18 from the external fluid reservoir 14. In an embodiment, the tether cable 34 is attached to, disposed within, on, or is integral to at least a portion of the flexible conduit 16. In an embodiment, the tether cable, the flexible fluid conduit, or both may be releasably attached to the external fluid reservoir, and/or to the brush base to facilitate authorized removal and/or replacement of any one of the various components of the system.

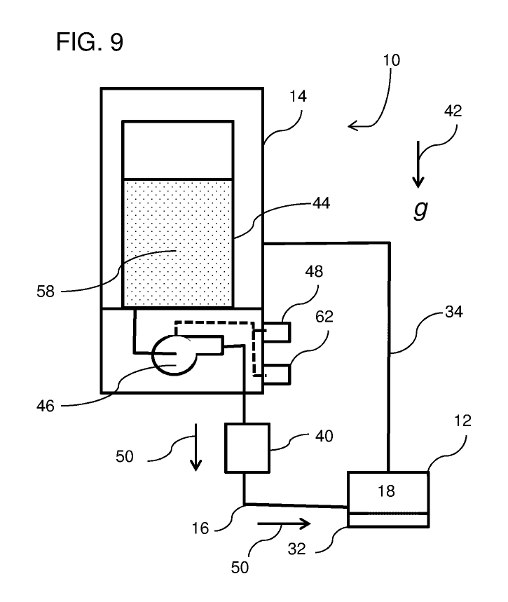

In an embodiment, as shown in block diagram form in FIG. 9, the system 10 may further comprise a one-way valve 40 located between the external fluid reservoir 14 and the brush assembly 12 arranged to prevent flow 50 of a fluid 58 through the flexible conduit 16 in a direction from the brush assembly 12 to the external fluid reservoir 14. Accordingly, the one-way or “check valve” 40 may be arranged to allow flow 50 in a direction from the external fluid reservoir 14 to the brush base 18, but not in a direction back from the brush base 18 into the external fluid reservoir 14. As such, elevation of the brush base above the external fluid reservoir would not result in flow of a fluid back into the external fluid reservoir 14.

In an embodiment, a motive force, or in an embodiment the sole motive force to produce a flow 50 of fluid 58 from the external fluid reservoir 14 through the flexible conduit 16 to the brush base 18 is gravity 42. In other words, a motive force to produce a flow 50 of fluid 58 from the external fluid reservoir 14 through the flexible conduit 16 to the brush base 18 comprises, consists essentially of, or consists of gravity 42. Accordingly, in an embodiment, the only motive force is gravity, in that the fluid is not actively pumped from the reservoir to the brush base.

In an embodiment, as shown in block diagram from in FIG. 9, the brush assembly 12 may be attached to, and be in fluid communication with an internal compartment 44 located on or in the external fluid reservoir 14 through the flexible conduit 16, and the external fluid reservoir 14 may further comprise a pump 46 in fluid communication with the internal compartment 44 and the flexible conduit 16, operable to produce a flow 50 of a fluid 58 disposed within the internal compartment 44 through the conduit 16 to the bottom side of the brush base 18.

In an embodiment, the pump 46 may be actuated by an external indicator, e.g., a button 48, or may be actuated by a proximity sensor, motion sensor, heat sensor, generally represented as 52, and/or the like, in electrical connection with pump 46 to provide a dosage of fluid 58 on-demand upon activation. In an alternative embodiment, the fluid 58 may pumped from the internal compartment 44 of the external reservoir 14 to the brush base 18 on a continuous or semi-continuous basis, or on-demand depending on the intended use of the system 10.

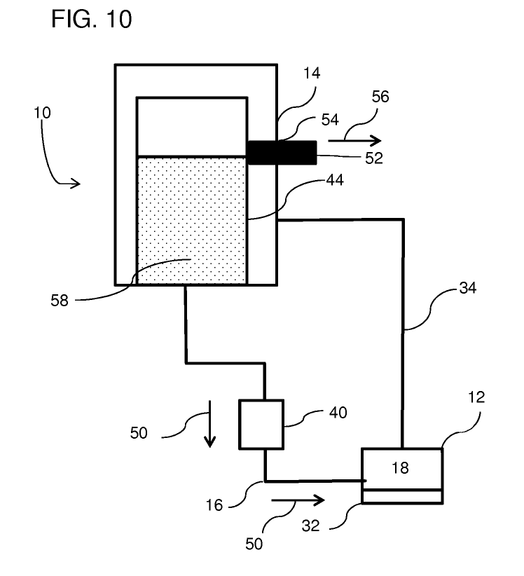

In an embodiment, as shown in block diagram from in FIG. 10, a scrub brush system 10 may comprise a scrub brush assembly 12 having a bristle assembly 32 comprising a plurality of bristles extending away from a bottom side of a brush base 18, the bottom side of the brush base attached to, and in fluid communication with a flexible internal compartment 44 of an external fluid reservoir 14 through a flexible conduit 16, the external fluid reservoir 14 further comprising a plunger 52 slidably engaged through an opening 54 in a wall of the external fluid reservoir 14 and arranged in outwardly biased contact 56 with the flexible internal compartment 44 such that application of a force on the plunger 52 opposite biased contact 56 produces a pressure differential between the flexible internal compartment 44 and the atmosphere resulting in a fluid 58 disposed within the flexible internal compartment 44 to flow 50 through the flexible conduit 16 to the bottom side of the brush base 18.

In an embodiment, the fluid 58 may be any liquid or slurry suitable for an intended use. In an embodiment, the fluid 58 is an aqueous or non-aqueous cleaning fluid, which may include liquid soap. In an embodiment, the fluid may comprise one or more solvents, acids, bases, reagents, steriulant, medicaments, particulates, gels, and/or sanitizing components, depending on the intended use.

In an embodiment, the cleaning fluid may be pumped continuously or semi-continuously as required from the reservoir to the brush in a cleaning line operation, such as, for example, in the preparation of fruits, vegetables, fish, beef and/or poultry for consumption, and/or various cleaning operations required in the manufacture of goods.

Accordingly, the present disclosure provides the following embodiments:
1. A scrub brush system comprising: a plurality of bristles extending away from a bottom side of a brush base, the bottom side of the brush base attached to, and in fluid communication with an external fluid reservoir through a flexible conduit.
2. The system according to embodiment 1, wherein the external fluid reservoir is in fluid communication with the bottom side of the brush base through a second fluid reservoir located on a top side of the brush base.
3. The system according to embodiment 1 or 2, further comprising a tether cable attached to the brush base and to the external fluid reservoir.
4. The system according to any one of embodiments 1 to 3, wherein a tether cable is attached to, disposed within, or is integral to at least a portion of the flexible conduit.
5. The system according to any one of embodiments 1 to 4, wherein the plurality of bristles are integral to the brush base.
6. The system according to any one of embodiments 1 to 4, wherein the plurality of bristles are removable from the brush base as a bristle assembly.
7. The system according to any one of embodiments 1 to 6, further comprising a one-way valve located between the external fluid reservoir and the brush base arranged to prevent flow through the flexible conduit in a direction from the brush base to the external fluid reservoir.
8. The system according to any one of embodiments 1 to 7, wherein the motive force to produce a flow from the external fluid reservoir through the flexible conduit to the brush base is gravity.
9. A scrub brush system comprising a scrub brush having a plurality of bristles extending away from a bottom side of a brush base, the bottom side of the brush base attached to, and in fluid communication with an internal compartment of an external fluid reservoir through a flexible conduit, the external fluid reservoir further comprising a pump operable to produce a flow of a fluid disposed within the internal compartment, through the conduit to the bottom side of the brush base.
10. The system according to embodiment 9, wherein the internal compartment is in fluid communication with the bottom side of the brush base through a second fluid reservoir located on a top side of the brush base.
11. The system according to embodiment 9 or 10, further comprising a tether cable attached to the brush base and to the external fluid reservoir.
12. The system according to any one of embodiments 9 to 11, wherein a tether cable is disposed within, or is integral to at least a portion of the flexible conduit.
13. The system according to any one of embodiments 9 to 12, wherein the plurality of bristles are integral to the brush base.
14. The system according to any one of embodiments 9 to 12, wherein the plurality of bristles are removable from the brush base as a bristle assembly.
15. The system according to any one of embodiments 9 to 14, further comprising a one-way valve located between the internal compartment and the brush base arranged to prevent flow through the flexible conduit from the brush base to the internal compartment.
16. A scrub brush system comprising a scrub brush having a plurality of bristles extending away from a bottom side of a brush base, the bottom side of the brush base attached to, and in fluid communication with a flexible internal compartment of an external fluid reservoir through a flexible conduit, the external fluid reservoir further comprising a plunger slidably engaged through an opening in a wall of the external fluid reservoir and arranged in outwardly biased contact with the flexible internal compartment such that application of a force on the plunger produces a pressure differential between the flexible internal compartment and the atmosphere resulting in a fluid disposed within the flexible internal compartment to flow through the flexible conduit to the bottom side of the brush base.
17. The system according to embodiment 16, further comprising a one-way valve located between the flexible internal compartment and the brush base arranged to prevent fluid flow through the flexible conduit from the brush base to the flexible internal compartment.
18. The system according to embodiment 16 or 17, further comprising a tether cable attached to the brush base and to the external fluid reservoir.
19. The system according to any one of embodiments 16 to 18, wherein a tether cable is disposed within, or is integral to at least a portion of the flexible conduit.
20. The system according to any one of embodiments 16 to 19, wherein the plurality of bristles are integral to the brush base.
21. The system according to any one of embodiments 16 to 20, wherein the plurality of bristles are removable from the brush base as a bristle assembly.

The foregoing disclosure and description of the invention is illustrative and explanatory thereof and it can be readily appreciated by those skilled in the art that various changes in the size, shape and materials, as well as in the details of the illustrated construction or combinations of the elements described herein can be made without departing from the spirit of the invention.

While the invention has been illustrated and described in detail in the drawings and foregoing description, the same is to be considered as illustrative and not restrictive in character, it being understood that only some embodiments have been shown and described and that all changes and modifications that come within the spirit of the inventions are desired to be protected. It should be understood that while the use of words such as preferable, preferably, preferred, more preferred or exemplary utilized in the description above indicate that the feature so described may be more desirable or characteristic, nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

1. A scrub brush system comprising:
a plurality of scrub brush bristles extending away from a bottom side of a brush base, the bottom side of the brush base attached to, and in fluid communication with an external fluid reservoir through a flexible conduit.

2. The system of claim 1, wherein the external fluid reservoir is in fluid communication with the bottom side of the brush base through a second fluid reservoir located on a top side of the brush base.

3. The system of claim 1, further comprising a tether cable attached to the brush base and to the external fluid reservoir.

4. The system of claim 3, wherein the tether cable is attached to, disposed within, or is integral to at least a portion of the flexible conduit.

5. The system of claim 1, wherein the plurality of scrub brush bristles are integral to the brush base.

6. The system of claim 1, wherein the plurality of scrub brush bristles are removable from the brush base as a bristle assembly.

7. The system of claim 1, further comprising a one-way valve located between the external fluid reservoir and the brush base arranged to prevent flow through the flexible conduit in a direction from the brush base to the external fluid reservoir.

8. The system of claim 1, wherein the motive force to produce a flow from the external fluid reservoir through the flexible conduit to the brush base is gravity.

9. A scrub brush system comprising a scrub brush having a plurality of scrub brush bristles extending away from a bottom side of a brush base, the bottom side of the brush base attached to, and in fluid communication with an internal compartment of an external fluid reservoir through a flexible conduit, the external fluid reservoir further comprising a pump operable to produce a flow of a fluid disposed within the internal compartment, through the conduit to the bottom side of the brush base.

10. The system of claim 9, wherein the internal compartment is in fluid communication with the bottom side of the brush base through a second fluid reservoir located on a top side of the brush base.

11. The system of claim 9, further comprising a tether cable attached to the brush base and to the external fluid reservoir.

12. The system of claim 11, wherein the tether cable is disposed within, or is integral to at least a portion of the flexible conduit.

13. The system of claim 9, wherein the plurality of bristles are integral to the brush base.

14. The system of claim 9, wherein the plurality of scrub brush bristles are removable from the brush base as a bristle assembly.

15. The system of claim 9, further comprising a one-way valve located between the internal compartment and the brush base arranged to prevent flow through the flexible conduit from the brush base to the internal compartment.

16. A scrub brush system comprising a scrub brush having a plurality of scrub brush bristles extending away from a bottom side of a brush base, the bottom side of the brush base attached to, and in fluid communication with a flexible internal compartment of an external fluid reservoir through a flexible conduit, the external fluid reservoir further comprising a plunger slidably engaged through an opening in a wall of the external fluid reservoir and arranged in outwardly biased contact with the flexible internal compartment such that application of a force on the plunger produces a pressure differential between the flexible internal compartment and the atmosphere resulting in a fluid disposed within the flexible internal compartment to flow through the flexible conduit to the bottom side of the brush base.

17. The system of claim 16, further comprising a one-way valve located between the flexible internal compartment and the brush base arranged to prevent fluid flow through the flexible conduit from the brush base to the flexible internal compartment.

18. The system of claim 17, further comprising a tether cable attached to the brush base and to the external fluid reservoir, wherein the tether cable is disposed within, or is integral to at least a portion of the flexible conduit.

19. The system of claim 18, wherein the plurality of scrub brush bristles are integral to the brush base.

20. The system of claim 19, wherein the plurality of scrub brush bristles are removable from the brush base as a bristle assembly.
